(19) United States
(12) Patent Application Publication
(10) Pub. No.: US 2013/0063246 A1
(43) Pub. Date: Mar. 14, 2013

(54) SYSTEM AND METHOD FOR ELECTRONICALLY PROVIDING AN ACCESS AUTHORIZATION

(71) Applicant: Timotheus Kim, Kitzbuhel (AT)

(72) Inventor: Timotheus Kim, Kitzbuhel (AT)

(73) Assignee: EASY AXESS GMBH I.G., Munchen (DE)

(21) Appl. No.: 13/580,478

(22) PCT Filed: Feb. 22, 2011
(86) PCT No.: PCT/EP2011/052590

§ 371 Date: Nov. 26, 2012

(30) Foreign Application Priority Data
Feb. 22, 2010 (AT) A 264/2010
Feb. 22, 2010 (DE) 10 2010 008 878.1

(51) Int. Cl. G05B 19/00

(52) U.S. Cl. 340/5.65

(57) ABSTRACT

System for electronically providing an access authorisation for a user, to a location selected by a user, comprising at least one access report device, which reports a user identification of the user, which is in each case stored on at least one portable data carrier of an user having access authorisation, via a data network to a forwarding device, which electronically forwards the reported user identification via the data network to at least one access read device, which is provided at the respective selected location and which grants the user access to the selected location if the user identification which is stored on the user's portable data carrier and is read off from the data carrier by the access read device corresponds to the user identification which is electronically forwarded to the access read device.

The invention relates to a system and a method for electronically providing an access authorisation for a user, in particular to a venue selected by a user, for a wide range of activities, using a platform and an individual personal digital user ID.

In many cases, it is necessary to obtain an access authorisation for a particular place and a particular timeframe. In particular for some events, for example concert events, theatre events, cinema events, sports events, exhibition events or even conference events, it is necessary for a participant or user to purchase access authorisations or entry tickets in advance, which are to be presented at the respective venue so as to gain access. A further example is passenger transport means in which a user purchases the access authorisation in the form of a travel ticket before he gains access to the passenger transport means. Passenger transport means of this type include trains, planes or even ships, for example.

As a result of the prevalence of the Internet, it is increasingly possible to obtain access authorisations of this type via Web-based portals, which for example offer tickets to venues for sale to end consumers or users. In this context, upon purchasing the ticket, a consumer conventionally obtains a booking number for each event which he has booked or for the venue which he has booked, the consumer generally additionally being sent a separate ticket by post. When the booking number or the sent ticket is presented, the consumer subsequently gains access to the respective event.

So as to prevent the access of unauthorised persons by means of counterfeited access authorisations or tickets, particular security measures are generally provided. Thus for example booking numbers may be compared with or verified against lists at the respective venue. However, for events having a large number of people who are attending the event, this is extremely impractical. So as to prevent tickets from being reproduced or counterfeited, the sent tickets or access authorisations normally further have copy protection features, for example holograms, magnetic strips or barcodes. If the sent tickets have magnetic strips or barcodes, the information stored therein can additionally be read off on site at the venue.

RFID access systems are a further conventional system for providing access authorisations, and are used for example on ski lifts or at exhibitions. In this context, the participant or the authorised entrant is issued an RFID card for the respective event. These RFID cards comprise an RFID chip, on which data for the respective event are stored. When the respective person enters the respective event, the access information which is stored on the RFID card is read off from the RFID chip or RFID card by read devices. For example, a skier who has purchased a week pass is issued a corresponding RFID card, the duration of the purchased week pass being stored in the chip of the RFID card. The fixed read devices which are provided on the ski lifts read off these access data and determine whether or not the respective ski pass is still valid. Although producing an individual RFID card of this type is relatively advantageous, a new RFID card has to be issued whenever a new day or week pass is purchased, and this involves a relatively large administrative expenditure.

However, the conventional systems for providing access authorisations have further major drawbacks. For example, if a person or user who has purchased an access authorisation or a ticket to a venue loses the ticket which he was sent by post, it is generally no longer possible for him to gain access to the respective event. For example, if a user or football fan loses an access authorisation or ticket to a popular football game, it is no longer possible for him to gain access to the respective football stadium. Anyone else who comes across the lost ticket can easily gain access to the venue. Since, from an access authorisation or ticket of this type, anyone can immediately see which event it is for, there is also an incentive to steal valuable access authorisations of this type.

If RFID cards are used for the access authorisation for the respective user, instead of printed tickets, there is also the risk that the information which is stored on the chip of the RFID card regarding the event can be read off by a third party, and there is thus further an incentive for third parties to steal a data carrier of this type comprising a stored access authorisation, and possibly to sell it on. Conventional systems for providing an access authorisation, which is stored or printed on a data carrier, thus have the drawback that there is an incentive for third parties to steal this data carrier and either gain access to the event themselves or possibly sell the stolen data carrier to further persons.

It is therefore an object of the present invention to provide a system and a method for electronically providing an access authorisation for a user in a particularly secure manner.

This object is achieved according to the invention by a system having the features specified in claim 1.

The invention provides a system for electronically providing an access authorisation for a user, to a location selected by a user, comprising at least one access report device, which reports a user identification of the user, which is in each case stored on at least one portable data carrier of an user having access authorisation, via a data network to a forwarding device, which electronically forwards the reported user identification via the data network to at least one access read device, which is provided at the respective selected location and which grants the user access to the selected location if the user identification which is stored on the user's portable data carrier and is read off from the data carrier by the access read device corresponds to the user identification which is electronically forwarded to the access read device.

In the system according to the invention, by contrast with conventional systems, no information relating to the location or venue which has been selected by the user is stored on the portable data carrier, but merely a unique user identification for the user. There is thus no way for a third party who comes into possession of the portable data carrier to discover information regarding one or more venues which were selected by the user, or to read off said information from the data carrier. There is therefore also no incentive for third parties to steal a data carrier of this type from an authorised user.

A further advantage of the system according to the invention is that no information data regarding possible venues selected by the user have to be stored on the portable data carrier, which only has limited storage space, and thus either the portable data carrier only has to have a very small storage space in total, or the available storage space can be used for other information data.

In one possible embodiment of the system according to the invention, the access read device which is provided at the respective selected location locally compares the user identification which is read off from the user's portable data carrier with user information which is electronically forwarded to the access read device by the forwarding device, the access read device only granting the user access to the selected location if the user identification which is read off from the user's portable data carrier matches a user identification which is electronically forwarded to the access read device by the forwarding device.

Thus, in this embodiment, the read-off user identification and the forwarded user identification are compared locally in the respective access read device, that is to say at the venue.

In one possible embodiment of the system according to the invention, after being installed and set in operation at the respective location, an access read device reports to the forwarding device and electronically receives the user identification of all the users who have selected the respective location.

In a further possible embodiment of the system according to the invention, the access read device which is provided at the respective location sends the user identification which is read of from the user's portable data carrier to the forwarding device, which centrally compares the user identification received from the access read device with all of the stored user identifications of registered users who have selected the respective location, the access read device sending an access authorisation grant message to the access read device if the received user identification matches one of the stored user identifications, and the access read device granting the user access to the location after receiving the access authorisation grant message.

Thus, in this alternative embodiment, the read-off user identification and all of the stored user identifications of registered users who have selected the respective location are compared centrally by a central forwarding device, that is to say not at the venue.

In one possible embodiment of the system according to the invention, the portable data carrier is an electronic identity card of the user, comprising a readable identity number as the user identification.

This embodiment has the advantage that a large number of users already have a portable data carrier of this type, and it is thus not necessary additionally to provide a separate portable data carrier for the system according to the invention. Moreover, this embodiment has the particular advantage that an electronic identity card of this type is particularly secure against counterfeiting. Moreover, this system has the further particular advantage that with an electronic identity card, a user can verify additional relevant information about himself, for example his age. For example, if the user wishes to access a particular event for which the user has to be an adult, the user can additionally use the electronic identity card to prove that he is of the required age.

In a further possible embodiment of the system according to the invention, the portable data carrier is a mobile terminal of the user, a readable device number of the terminal serving as the user identification. This embodiment has the further advantage that mobile terminals of this type are widespread, and most users constantly carry said terminals around with them in any case.

In one, possible embodiment, the mobile terminal is a mobile telephone, a laptop, a smartphone or a PDA.

In a further possible embodiment of the system according to the invention, the portable data carrier is a user card or a user chip of a user who is registered on the forwarding device, comprising a readable membership number as the user identification. This embodiment has the advantage that as a registered member, the user who is in possession of a user card or user chip of this type can select various venues. A user card or user chip of this type can thus be used universally for a wide range of events. The user chip may for example be an RFID chip which is located on a card or for example attached to the housing of a mobile terminal, for example to the housing of a mobile telephone, by means of a sticker.

In one possible embodiment of the system according to the invention, the user can register himself as a member on the forwarding device with one or more user identifications of the user. The forwarding device may for example be a central server or a central Web-based portal. With the system according to the invention, it is thus possible to register oneself as a member not only with one, but also with a plurality of user identifications.

In one possible embodiment of the system according to the invention, an access authorisation to the respective location can be transferred from one registered user to another registered user, in that the user having access authorisation reports the transfer to the forwarding device while specifying the other user, the forwarding device replacing the user identification of the reporting user with the user identification of the other user for the respective location. The system according to the invention thus makes it possible to transfer the access authorisation to other registered users, for example if a user does not have the opportunity to participate in the event which he has booked.

In a further embodiment of the system according to the invention, the access read device which is provided on site additionally compares the spatial coordinates of the mobile terminal which is used as the portable data carrier with its own spatial coordinates, and only grants access to the location if the spatial coordinates virtually match. In this embodiment, a mobile terminal, for example a mobile telephone, is used as the data carrier, it being possible for a readable device number of the terminal to serve as the user identification. In this embodiment, the access read device additionally has a means for determining its own spatial coordinates, for example a GPS receiver. The spatial coordinates of the mobile telephone are compared with the spatial coordinates of the access read device at the venue, in such a way that additional security against manipulation can be achieved.

In a further possible embodiment of the system according to the invention, a user carries around a plurality of portable data carriers, which each have their own user identification of the user. In this context, the access read device only grants access to the selected location if all of the user's user identifications which are read off from the various data carriers correspond to the associated user identifications which are electronically forwarded to the access read device.

In this embodiment, the user carries around a plurality of portable data carriers, for example an electronic identity card and additionally a user card or a user chip, the access read device only granting access if the user's user identifications which are read from the two different data carriers each correspond to the respective user identification which is forwarded to the access read device. This embodiment of the system according to the invention thus also increases the security against manipulation. This embodiment is therefore particularly suited to locations which require particularly high access security, for example company divisions where highly sensitive data are available.

In one possible embodiment of the system according to the invention, the location is a defined venue, for example a concert venue, a theatre venue, a cinema venue, a sports venue, an exhibition venue or a conference venue.

In an alternative embodiment of the system according to the invention, the location is a defined region within a building, for example a specially secured division within a company.

In a further possible embodiment of the system according to the invention, the location is a passenger transport means, for example a passenger transport train, a passenger aircraft or a passenger ship.

In one possible embodiment of the system according to the invention, after access has been granted, the forwarding device receives an access report for the respective user from the access read device. In this way, the forwarding device discovers that access has been granted to the respective user.

In a further possible embodiment of the system according to the invention, after receiving the access report, the forwarding device forwards further specific location information data to the respective user, for example a seat number, a standing region block number, an exhibition stand number, a parking space number or a ski lift number. For example, if the user has a mobile terminal, in particular a mobile telephone, after access to the venue has been granted the forwarding device can forward further information to the user, which is displayed for example on a display of the mobile telephone. For example, after access is granted to a concert, a seat number is displayed to a user on the display of his registered mobile telephone, this display additionally providing the user with proof on site that the displayed seat was actually booked by him, and not by someone else. Further, the user having the displayed seat number can ask the staff at the venue which way to go to find his seat.

The invention further discloses an access read device for an access authorisation system, comprising

an interface for reading off a user identification from a user's portable data carrier,

an interface for receiving an electronically forwarded user identification, and

comprising an evaluation unit, which compares the read-off user identification with the received user identification and grants the user access to the location if the user identification which is read off from the data carrier matches the electronically forwarded user identification.

The invention further relates to a forwarding device for an access authorisation system, comprising

an interface for receiving a user's user identification and a location which has been selected by the user, and comprising an evaluation unit, which compares the received user identification with user identifications which are stored in a database, and, if they match, electronically forwards the user identification to at least one access read device which is provided at the respective location.

The invention further relates to a method for electronically providing an access authorisation for a user,

wherein a user identification which is stored on a portable data carrier of the user and a location which has been selected by the user are reported to a forwarding device, which forwards the reported user identification to at least one access read device which is provided at the respective location and which grants the user access to the location if the user identification which is stored on the user's data carrier and which is read off from the data carrier by the access read device corresponds to the user identification which is electronically forwarded to the access read device.

In the following, possible embodiments of the system according to the invention and the method according to the invention for electronically providing an access authorisation for a user, to a location selected by the user, are described with reference to the appended drawings, in which:

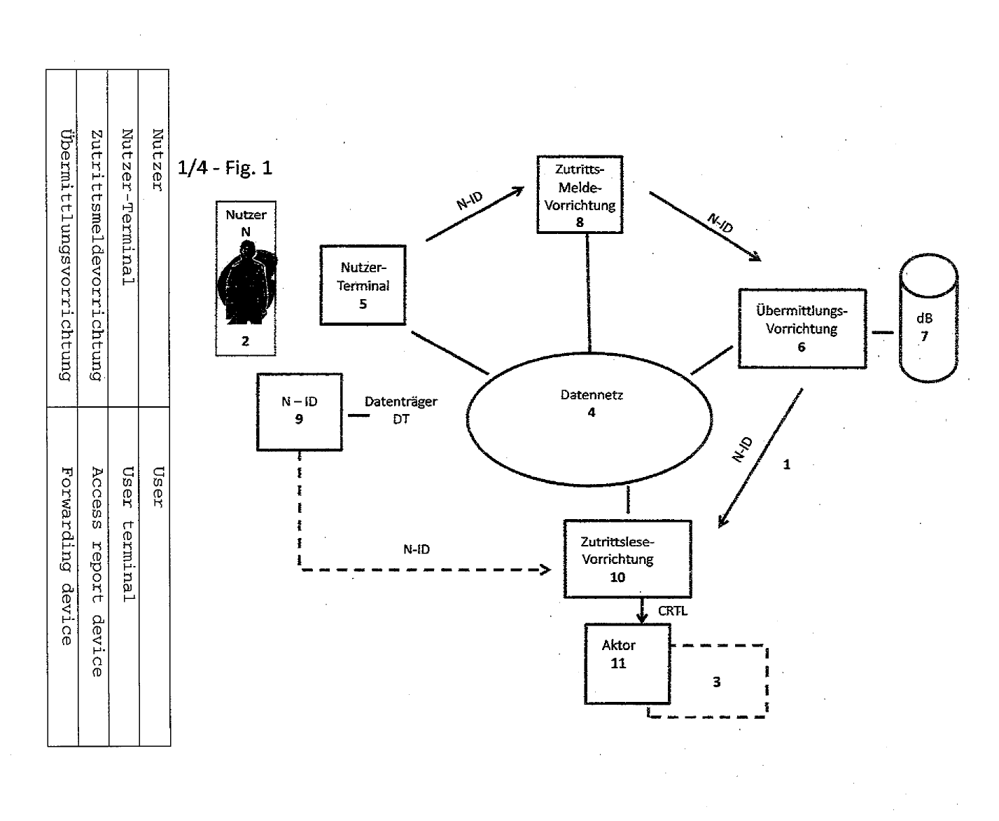

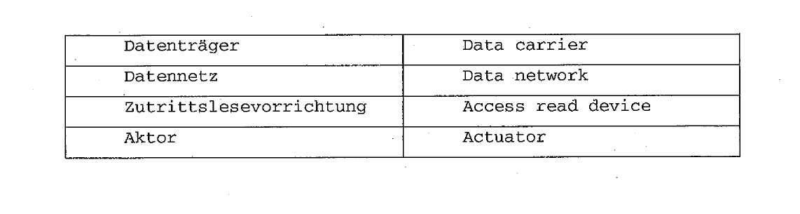

FIG. 1 is a diagram illustrating the embodiment of a system according to the invention for electronically providing an access authorisation for a user;

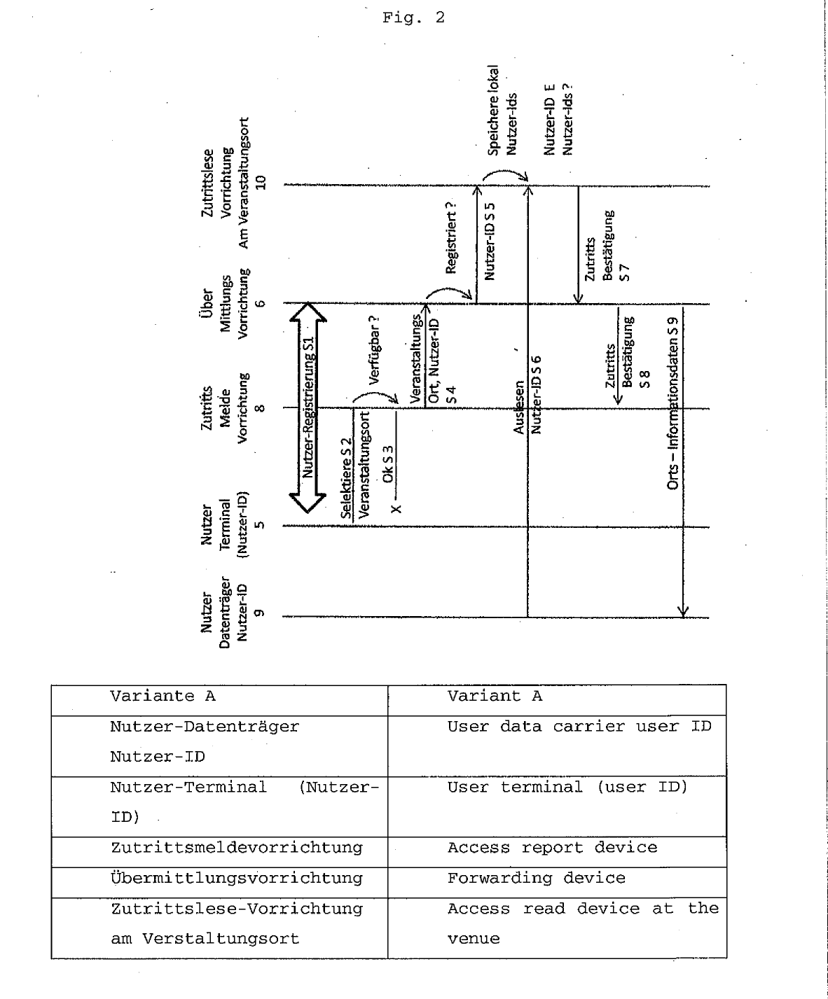

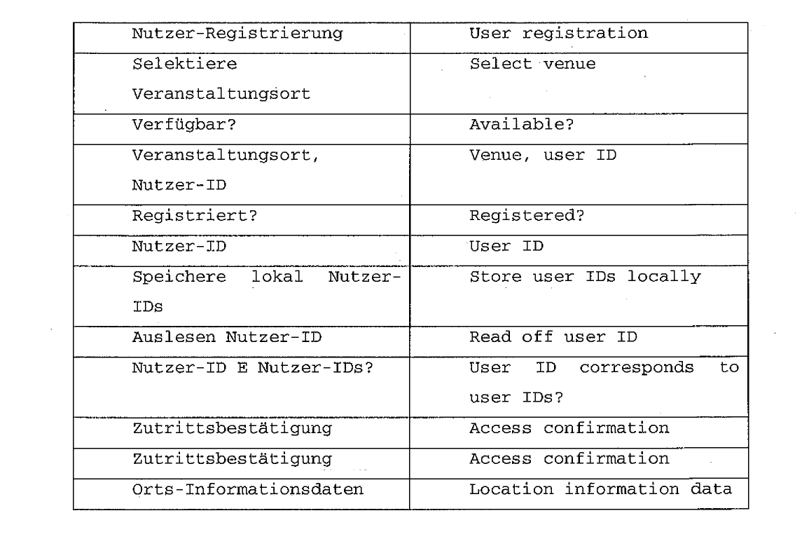

FIG. 2 is a signal diagram illustrating the mode of operation of one possible embodiment of the method according to the invention and the system according to the invention for electronically providing an access authorisation for a user;

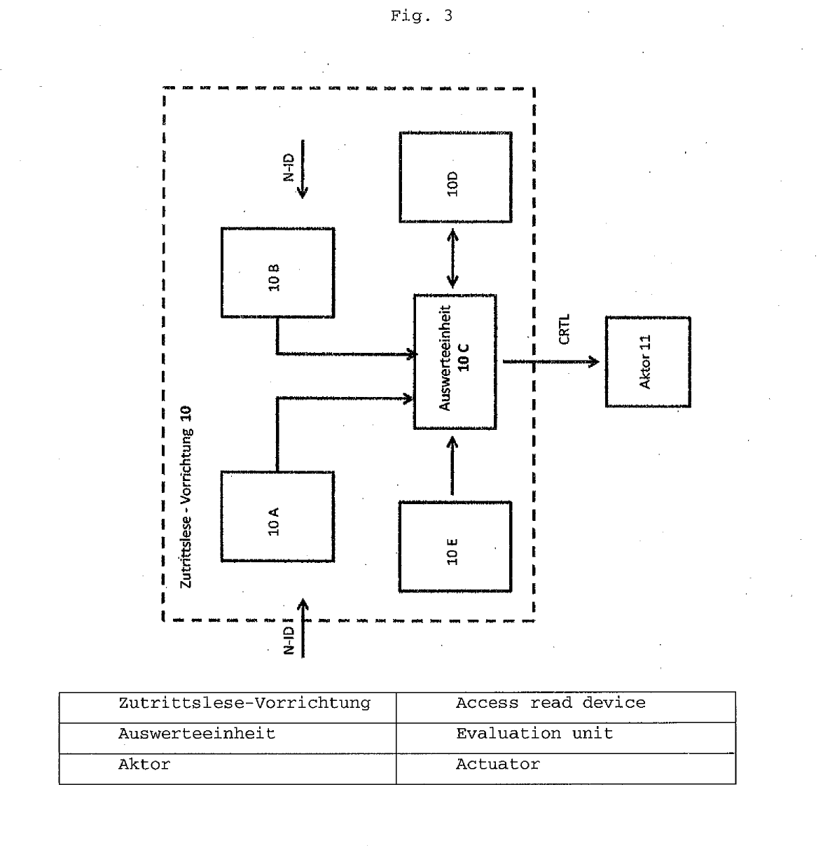

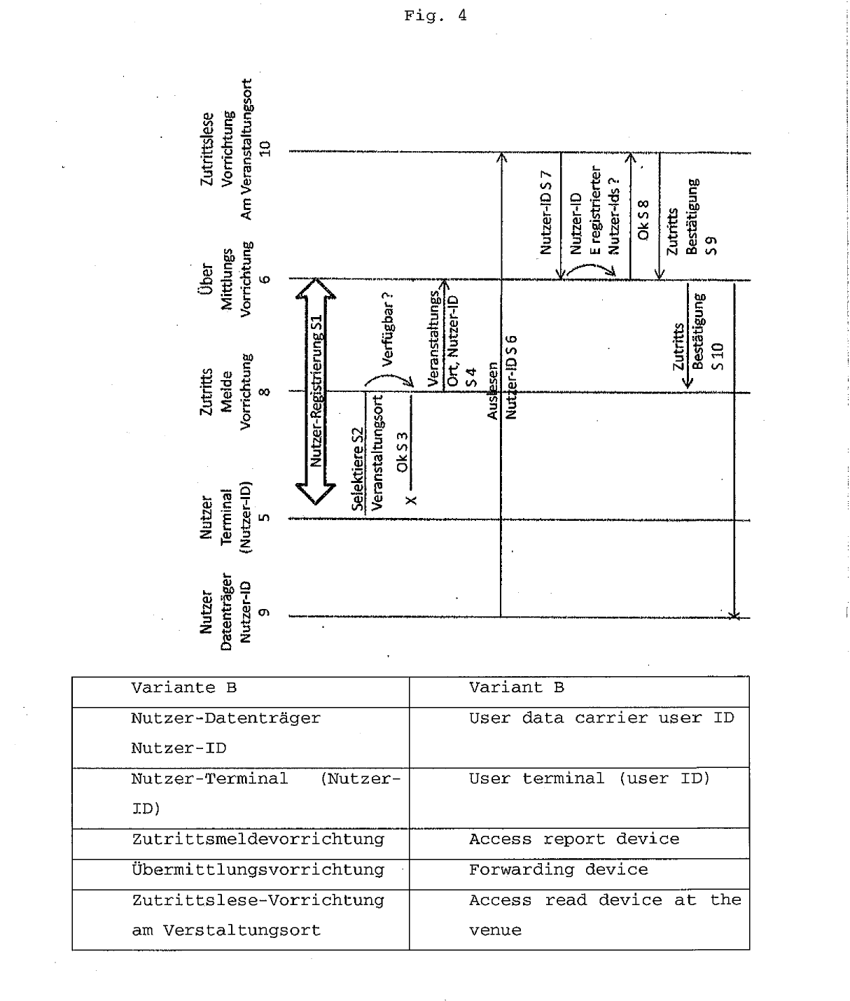

FIG. 3 is a block diagram illustrating an embodiment of an access read device according to the invention;

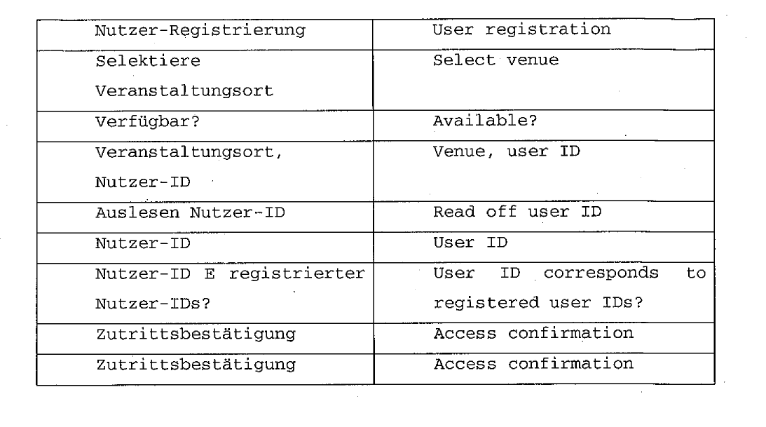

FIG. 4 is a signal diagram illustrating the mode of operation of a further embodiment of a system according to the invention and a method according to the invention for electronically providing an access authorisation for a user.

As can be seen from FIG. 1, a system 1 for electronically providing an access authorisation for a user 2, to a location 2 selected by the user 2, has a plurality of components, which may be interconnected via a data network 4. The data network 4 may be a combination of data networks, for example the Internet. In an alternative embodiment, the data network is a local network, for example a local network LAN of a company. A user 2 has a user terminal 5, which can be connected to the data network 4. Via this user terminal 5, the user 2 can register himself on a central forwarding device or a forwarding server 6, it being possible for a user ID of the registered user to be stored in a database 7 by the forwarding device 6. This makes it possible for the user 2 to obtain an access authorisation to the venue 3 via an access report device 8 or an access report server 8. The access report device 8 is also connected to the data network 4.

The user 2 has at least one portable data carrier 9, on which a user identification N-ID of the user 2 is stored. This portable data carrier 9 may, in one possible embodiment, be an electronic identity card of the user 2, on which a readable personal identity number is stored as the user identification N-ID. Alternatively, the portable data carrier 9 may also be a mobile terminal of the user 2, comprising a readable device number of the terminal as the user identification N-ID. The mobile terminal may for example be a mobile telephone, a laptop, a smartphone or a PDA of the user 2. Further, the portable data carrier 9 may be a user card or a user chip, in particular an RFID chip of a user 2 who is registered on the forwarding device 6, comprising a readable member number as user identification.

In one possible embodiment, the user 2 initially registers himself as a member or registered user on the forwarding device 6 or the forwarding server with one or more user identifications N-ID of the user. With an access report device 8, the user 2 can subsequently selected a desired location, the user 2 identifying himself by means of his user identification N-ID to the access report device 8, which reports the user identification N-ID of the user 2 to the central forwarding device or the central forwarding server 6. The forwarding device 6 electronically forwards the user identification N-ID which is reported thereto to at least one access read device 10, which is provided at the respectively selected location, via the data network 4, as is shown in FIG. 1. This access read device 10 only grants the user 2 access to the selected location 3 if the user identification N-ID which is stored on the user's 2 portable data carrier 9 and which is read off from the data carrier 9 by the access read device 10 corresponds to the user identification N-ID′ which is electronically forwarded to the access read device 10. In one possible embodiment, the access read device 10 only grants the user access to the selected location 3 if the user identification N-ID which is read off from the portable data carrier 9 is identical to the forwarded user identification NID′. In one possible embodiment, the access read device 10 controls an actuator 11, for example an access barrier, and only opens the barrier 11 if the read-off user identification N-ID matches the electronically forwarded user identification N-ID′. In the system 1 according to the invention, as shown in FIG. 1, for electronically providing an access authorisation for a user 2, no information data regarding the venue 3 which has been selected by the user 2 are stored on the portable data carrier 9. A third party who steals or comes across the user's 2 portable data carrier 9 thus has no information regarding venues which have been booked by the user 2, and can thus neither use the data carrier 9 himself nor sell it on to others.

The venue 3 shown in FIG. 1 may be a spatially defined venue, for example a concert venue, a theatre venue, a cinema venue, a sports venue, an exhibition venue or even a conference venue. As well as this, the defined location 3 may be a defined region within a building, for example a security division. Further examples of security divisions of this type are divisions comprising sensitive company data or closed-off divisions within a psychiatric institution. In a further possible embodiment of the system 1 according to the invention, the selected defined location 3 is a passenger transport means, for example a passenger train, a passenger aircraft or a passenger ship. The location 3 shown in FIG. 1 may be a locally fixed location, for example a football stadium, or else a movable location, for example a railway train.

The system 1 according to the invention, as shown in FIG. 1, makes it possible to book or obtain access to a wide range of venues by means of a data carrier 9 or a user identification N-ID of the user 2 at various access report devices 8, for example concert tickets, railway tickets and tickets for a ski lift. The access report device 8 may be a Web-based portal for purchasing access authorisations. In one possible embodiment, the data carrier 9 is a mobile terminal of the user 2. In this embodiment, it is possible for this mobile terminal to be used simultaneously as a user terminal 5 for registering the user 2 on the forwarding device 6 and for purchasing access authorisations on the access report device 8. Thus, in this embodiment, the user terminal 5 and the portable data carrier 9, as shown in FIG. 1, are formed by a single device.

In one possible embodiment, the user 2 does not only have a single portable data carrier 9, on which a user identification N-I of the user 2 is stored, but has a plurality of potable data carries 9 comprising identical or different user identifications of the user 2. For example, as well as an electronic identity card as a first data carrier 9-1, of which the identity number forms a first user identification N-ID₁, the user 2 additionally has a mobile terminal 9-2, of which the readable device number serves as a further user identification N-ID₂, and optionally further has a user card or a user chip 9-3 comprising a readable member number as a further user identification N-ID₃. In this simple example, the user 2 thus has three different data carriers 9 comprising three user identifications N-ID. In this embodiment, the user 2 can thus register himself as a user on the forwarding device not just with one, but with a plurality of user identifications. In this embodiment, the user 2 carries around not just one, but a plurality of data carriers 9-1, 9-2, 9-3, so as to gain access by way of the access read device 10 which is connected at the respective venue 3. In this context, the access read device 10 checks for example not only the identity number N-ID₁ which is read off from the carried electronic identity card, but also the member number N-ID₃ of the user card or user chip 9-3 which is also carried, and optionally also the device number a of the terminal 9-2, which is read off from the mobile terminal 9-2 which is also carried, as a further user identification N-ID₂ of the user.

In one possible embodiment, different security levels may be defined, the user 2 only being granted access for a high security region 3 if all of the user identifications N-IDᵢ which are read off from the different data carriers 9-i match the user identifications which are stored in the database 7. For less critical venues, for example a concert venue, it is only required for example to present a user card or a user chip on which the correct user identification is stored, which matches the electronically forwarded user identification NID′.

In one possible embodiment of the system 1 according to the invention, an access authorisation which is purchased by a user 2 to a venue 3 can be transferred from the registered user 2 to another registered user 2′. In one possible embodiment, the user 2 having access authorisation reports the transfer on the forwarding device 6 while specifying the other user 2′. In one possible embodiment, the forwarding device 6 replaces the user identification N-ID of the reporting user 2 with the user identification of the other user 2′. If, as a result of a commitment at a different time, it is not possible for the user 2 to participate in an event which he has booked, it is thus easily possible for him to transfer his access authorisation to another user 2′, as long as this other user is also registered as a user on the forwarding device 6.

In a further possible embodiment of the system 1 according to the invention, the access read device 10 which is provided at the location additionally compares the spatial coordinates x, y, z of the mobile terminal which is used as a portable data carrier 9 with its own spatial coordinates, and only grants access to the location 3 if the spatial coordinates virtually match. If for example a mobile terminal, in particular a mobile telephone of the user 2, is used as the mobile data carrier 9, and the readable device number of the mobile terminal is used as the user identification N-ID, the access read device 10 can additionally compare the spatial coordinates x, y, z of the mobile terminal 9 which is read on site with its own spatial coordinates, and optionally only grant access if the spatial coordinates virtually match. This measure can be used to provide additional security against manipulation.

In one possible embodiment, a large number of different access read devices 10 are set up at a venue 3. These access read devices 10 are preferably access read devices 10 which are set up to be mobile and which are also portable to some degree, and with which it is possible to read off a portable data carrier 9 locally. In this context, the reading is preferably contactless, via an air interface. This embodiment has the advantage that a plurality of users 2 can pass through a barrier 11 which is controlled by the access read device 10 in a relatively short time. For example, the data from the data carrier 9 are read out by an RFID read device 10 or via a Bluetooth interface. Alternatively, a barcode or magnetic strip which is provided on the data carrier 9 can be read off by the access read device 10 so as to obtain the user identification N-ID of the user 2.

In one possible embodiment, after being installed and set in operation, an access read device 10 which is set up at the respective location 3 initially reports to the forwarding device 6 by transmitting a corresponding report device to the forwarding device 6 or forwarding server via the data network 4. Thereupon, the forwarding device 6 forwards the user identifications N-ID of all of the users 2 who have selected the respective venue 3. The electronically forwarded user identifications N-ID of all of the users 2 who have selected the corresponding venue 3 can be forwarded to the various access read devices 10 which are set up at the venue, where they can be stored locally. Whilst the user 2 carries around the portable data carrier 9, in one possible embodiment of the invention, before the access barrier 11 at the venue 3 is opened the access read device 10 can read off the user identification N-ID which is provided on the data carrier 9 and compare it with all of the user identifications which are stored in its own local data memory. If the user identification N-ID contained in the data carrier N-ID is identical to one of the group of stored user identifications N-ID′, which are stored in the local data memory of the access read device 10, the user 2 can pass through the access barrier 11 and gain access to the venue 3.

In one possible embodiment, the user identification N-ID which is read off from the portable data carrier 9 and the user identification of the registered user who selects the location 3 can be verified at the venue 3 by the access read device 10, in a local or decentralised manner. In an alternative embodiment, the read-off user identification N-ID and the user identification of the registered user 2 who has selected the location 3 are verified centrally, for example in the forwarding device 6.

FIG. 2 is a signal diagram illustrating an embodiment of the system 1 according to the invention for electronically providing an access authorisation, in which the user identification N-ID is verified or evaluated in a decentralised manner by the respective access read device 10.

Initially, in a step S1, user registration of a user 2 on the forwarding device or the forwarding server 6 is provided by means of a user terminal 5. The registered user identifications are stored for example in a local database 7 of the forwarding device 6.

In a further step S2, a user 2 selects a desired venue 3, for example a concert venue, on an access report device 8, for example a Web-based ticket portal. The access report device 8 initially checks whether the desired venue is still available or corresponding places are still available. Optionally, the access report device 8 may additionally check whether the querying user 2 is actually registered on the forwarding device 6, in that the access report device 8 directs a corresponding query to the forwarding device 6. If the desired venue is available and the user 2 is registered on the forwarding device 6, in step S3 the access report device 8 can confirm the order and report to the user via his user terminal 5 that access to the desired venue 3 at the desired time is possible and available. Subsequently, in step S4 the access report device 8 reports the selected venue 3 and the user identification N-ID′ of the selecting user 2 to the forwarding device 6. The forwarding device 6 may optionally subsequently also check whether the forwarded user identification N-ID′ belongs to a registered user 2. Subsequently, in step S5, the user identification N-ID′ is buffered in a data memory of the forwarding device 6, along with the selected venue 3 and the desired venue timeframe, and forwarded to the access read device 10 at the venue 3 at a given time. For example, if a selected concert at the desired venue 3 is only taking place in the future, for example in three months, it is possible that the access read device 10 may not yet have been set up at the specified venue 3 at the time when the user 2 selects the venue 3. In this case, the user identification N-ID′ of the selected user 2 is buffered in a data memory of the forwarding device 6, and only forwarded to the access read device 10 once it has been set up. For this purpose, in one possible embodiment, the access read device 10 may send a report, which specifies that the access read device 10 has now been set up at the venue 3, to the forwarding device 6 via the data network 4. If, in an alternative embodiment, the access read device 10 is constantly, permanently installed at a venue 3, for example at the entrance to a football stadium, the user identification N-ID may already be forwarded from the forwarding device 6 to the access read device 10, where it is stored, in advance in step S5.

If the user with his portable data carrier 9, on which the user identification N-ID is stored, approaches the access read device 10, in the embodiment shown in FIG. 2 the stored user identification N-ID is read off from the portable data carrier 9 automatically by the access read device 10 in step S6. In the embodiment shown in FIG. 2, the access read device 10 compares the read-off user identification N-ID with all of the user identifications N-ID′, which are stored locally therein, of registered users 2 who have selected the respective venue 3. If the read-off user identification N-ID′ is in the group of stored user identifications N-ID′ which are stored locally in the access read device 10, the actuator 11, for example an access barrier, is opened by the access read device 10 and the user 2 gains access to the venue 3. In one possible embodiment, in step S7 the forwarding device 6 additionally receives an access confirmation from the access read device 10, which the forwarding device forwards to the access report device 8 in step S8 in one possible embodiment.

In one possible embodiment, after receiving the access confirmation in step S7, that is to say after access is granted, the forwarding device 6 additionally transmits further specific location information data to the user 2 in step S9. If the portable data carrier 9 is for example a mobile terminal, for example a mobile telephone, or if the user 2 has a corresponding mobile telephone in addition to the portable data carrier 9, in step S9 the forwarding device 6 can forward further specific location information data about the venue 3 to the user 2, which are displayed for example on a display of the mobile telephone. These location information data comprise for example a seat number, a standing region block number, an exhibition stand number, a room number, a parking space number or for example a ski lift number. In this way, it is possible for the user 2 for example to find his seat on site at the venue and to prove by means of the display that the seat was actually booked by him. Further variant embodiments are possible. For example, in one possible embodiment the forwarding device 6 can additionally navigate the user 2 to his seat or show him the way there.

FIG. 3 shows an, embodiment of an access read device 10, which can be set up at a venue 3. The access read device 10 comprises a first interface 10A for reading off a user identification N-ID from a portable data carrier 9 of a user 2. Further, the access read device 10 comprises a second interface 10B for receiving an electronically forwarded user identification N-ID via the data network 4 from the forwarding device 6. In a preferred embodiment, the first interface 10A reads the user identification N-ID off from the user's 2 portable data carrier 9, contactlessly via an air interface. The second interface 10B can preferably be connected to a data network 4 in an access-secured manner. In one possible embodiment, the access read device 10 is a hand-portable read device. In this embodiment, the two interfaces 10A, 10B may be wireless interfaces. The two interfaces 10A, 10B are connected to an evaluation unit 10C of the access read device 10. The evaluation unit 10C is formed for example by a microprocessor which carries out a corresponding evaluation program. In the embodiment shown in FIG. 3, the evaluation unit 10C of the access read device 10 compares the user identification N-ID which is read off by the first interface 10A with the electronically transmitted user identification N-ID′ which is received by the second interface 10B, and only grants the user 2 access to the venue 3 if the user identification N-ID which is read off from the data carrier 9 matches the electronically forwarded user identification N-ID′. In one possible embodiment, the evaluation unit 10C has access to a local data memory 10D, which stores the user identifications N-IDs of all of the registered users 2 who have selected the respective venue 3 at the corresponding time, which have been transmitted from the forwarding device 6 via the data network 4 to the access read device 10 via the second interface 10B in advance of the event. If the user identification N-ID which is read off from the data carrier 9 is identical to a user identification N-ID′ which is stored in the local data memory 10D, the evaluation unit 10C can transmit a control signal CTRL to the actuator 11, which for example opens an access barrier to the venue 3 for the respective user 2 and thus grants the user 2 access to the venue 3.

In a possible further embodiment, the access read device 10 may comprise a unit 10E which provides spatial coordinates of the access read device 10. This unit 10E may for example be in the form of a GPS receiver. In a possible variant embodiment, the evaluation unit 10C additionally compares the spatial coordinates of the access read device 10, which are provided by the GPS receiver 10E, with the spatial coordinates of a mobile terminal which the user 2 brings with him as a portable data carrier 9 when accessing the venue 3. In this variant embodiment, the user 2 is only granted access to the venue 3 if the spatial coordinates of his mobile terminal 9 broadly match the spatial coordinates of the access read device 10.

Further variants are possible. For example, storage can be provided in the data memory 10D of the access read device 10 for the respective event, in such a way that the user 2 not only has to have a data carrier 9 comprising a first user identification but has to have at least one further portable data carrier 9 comprising a further user identification N-ID₂, so as to gain access to the venue 3. In this embodiment, the evaluation unit 10C compares each of the user's user identifications N-IDs which are read off from the various data carriers 9 with the associated user information which is transmitted electronically to the access read device 10. The user 2 only gains access to the venue 3 if all of the user's 2 user identifications N-IDs which are read off from the various data carriers 9 correspond to the associated user identifications N-ID's which are transmitted electronically to the access read device.

In one possible embodiment, a plurality of venues 3 are nested—inside one another, that is to say a central event region has a higher security level than a peripheral event region, the respective access read devices 10 for the inner event region having a higher security level and requiring a larger number of user identifications N-ID from various data carriers 9 for access by the respective user 2. For example, in this variant embodiment, for access to the peripheral venue the user 2 merely presents his mobile telephone 9 having the device number stored thereon as user identification N-ID, so as to gain access to the peripheral event region, the user 2 additionally having to present his electronic identity card for access to a central region.

In one possible embodiment of the system 1 according to the invention, the user 2 uses the portable data carrier 9 not only to gain access to the venue 3, but also to leave this venue again. In a further possible variant, the access authorisation is not checked upon accessing the location 3, but only upon leaving the selected location 3.

FIG. 4 shows a further variant embodiment of the system 1 according to the invention for electronically providing an access authorisation for a user 2. In the variant embodiment shown in FIG. 4, the first steps S1, S2, S3, S4 are identical to the variant embodiment shown in FIG. 2. By contrast with the variant embodiment shown in FIG. 2, the user identification N-ID′ is not forwarded from the forwarding device 6 via the data network 4 to the access read device 10, since in the embodiment shown in FIG. 4 the user identifications are evaluated centrally, by the forwarding device 6 or the forwarding server 6, rather than in a decentralised manner in the access read devices 10. In the variant embodiment shown in FIG. 4, in step S7, the user identification N-ID which was read off in step S6 is electronically transmitted from the access read device 10 at the venue 3, for example via the interface 10B and the data network 4, to the forwarding device 6, where it is evaluated. The forwarding server 6 checks whether the received user identification, which it has received from the access read device 10 via the data network 4, matches one of the user identifications N-ID of registered users 2 which are stored for the respective event. If this is the case, this is reported to the access read device 10 in step S8 by the forwarding device 6, and the access read device 10 grants the user 2 access to the selected event. Furthermore, in step S9 the access read device 10 may transmit a corresponding access confirmation back to the forwarding device 6, which in step S10 can pass on the access confirmation to the access report device 8. If the portable data carrier 9 is a mobile terminal of the user or if the user 2 brings his mobile terminal with him, in step S11 the forwarding device 6 can additionally transmit further location information data to the user's 2 mobile terminal, for example a seat number.

The variant embodiment shown in FIG. 4 has the advantage that the user identifications do not have to be evaluated by the access read device 10, in such a way that the technical expenditure and the complexity of the corresponding access read devices 10 is lower than in the variant of the access read device 10 shown in FIG. 3. However, the variant embodiment shown in connection with FIG. 2 and FIG. 3 has the advantage that there does not have to be a data connection between the access read device 10 via the data network 4 to the forwarding device 6 immediately before the event, in such a way that this variant embodiment is largely immune to disruption of the network connection before the event. In the variant embodiment shown in FIG. 2, the user identifications N-ID′ can be transmitted to the access read devices 10 by the forwarding device 6 previously in advance of the event, for example a whole two hours before the planned event. If the data connection between the forwarding device 6 and the access read devices 10 via the data network 4 subsequently fails, the access read devices 10 already have the user identifications N-ID′ of virtually all of the users 2, and only the users who booked the event at the last minute cannot be verified.

In one possible embodiment, the variant embodiments shown in FIG. 2 and FIG. 4 are combined, that is to say the user identifications are aligned both in the access read device 10 and in the forwarding device 6. As a result, the security of the access system 1 can be further increased. The user 2 is only granted access to the venue 3, by actuating the actuator 11, if the evaluation by the access read device 10 and the evaluation by the forwarding device 6 both specify that the respective user 2 has access authorisation.

In one possible embodiment of the system 1 according to the invention, it is used for ticket sales by a user or consumer, the access report device 8 forming a ticket sales device on which a user 2 purchases an access authorisation for an event or a venue 3. In this context, an identification of the user or consumer 2 and information about the event or venue are forwarded from the access report device 8 or the ticket sales point to the access read device 10. Subsequently, the consumer or user 2 is identified by way of the identification or user identification at the access read device 10.

The portable data carrier 9 may be a transponder. Furthermore, it is possible for the portable data carrier or the read-off means to be an RFID chip, it being possible for the RFID chip to be located in a card or for example to be attached to a mobile terminal, in particular a mobile telephone, by means of a sticker. In one possible embodiment, the mobile data carrier 9 is a mobile telephone, it being possible for the MAC address of the mobile telephone to serve as the identification. Furthermore, it is possible for the identification to be stored in a magnetic strip, it being possible for the magnetic strip to belong to a debit card or credit card.

Once the access authorisation has been purchased, the ticket sales point or the access report device 8 forwards an identification of the user 2 and information data for the respective event or the venue 3 to the access read device 10. By way of the received identification of the user and the information about the event or the venue 3, in one possible embodiment the access read device 10 may determine which user should actually gain access to the respective event or venue. With the system 1 according to the invention, the user or consumer merely has to identify himself at the access read device 10 by way of his identification. Since the same identification is used by the consumer and by the organisation, that is to say the organiser of the event at the venue 3, copy security is greatly increased with the system 1 according to the invention. To circumvent the security provided by system, the identification or user identification N-ID would have to be manipulated in both instances, that is to say both with the consumer and with the organisation.

A further advantage of the system 1 and method according to the invention is that it can be used in parallel for any events or venues. For example, it is possible to use the same method for booking a lift ticket on a ski holiday and for an entry ticket to a concert. As a result, the previous expenditure for the ticket holder or user and for the organiser of the event is reduced considerably.

A large number of different services are possible with the system 1 according to the invention. For example, an access authorisation to a hotel room, as the location 3, can also be purchased by the method according to the invention. In this case, the access report device 8 or ticket sales device is a platform for a hotel booking. A further example is the purchase of parking tickets for car parks and the like.

In one possible embodiment, a loyalty card can be used as the user's 2 or consumer's identification. This loyalty card comprises a readable user identification N-ID. A further variant involves using a transponder as the portable data carrier 9, which may for example be integrated into a piece of clothing, a piece of jewellery, a watch, a pendant or a mobile telephone. With the system 1 according to the invention, the transponder or the portable data carrier 9 is preferably integrated into a device which the consumer or user 2 carries around with him in any case. As a result, the risk of forgetting the data carrier 9 or losing the user identification is greatly reduced.

The information data, in particular the user identification N-ID, are preferably transmitted via a secured, cryptographically encrypted data path, so as to prevent abuse in so far as possible. The portable data carrier 9 or the identification card is preferably re-useable. With the system 1 according to the invention, the user or consumer 2 does not have to use different cards to attend respectively different events. Furthermore, the system 1 according to the invention has the advantage that the host or organiser of the event or the seller of the access authorisation does not have to issue and manage any cards itself for the access authorisation. As a result, the administrative and technical expenditure are greatly reduced both for the host and for the purchaser.

In a further possible variant embodiment, the portable data carrier 9 is an identification card which can additionally be used as a means of payment. In this variant embodiment, the identification card is simultaneously a credit card or bank card. Cards of this type also provide unique identification of the customer, in such a way that with the access system 1 according to the invention, this identification can be used not only for monetary transactions, but also for the access authorisation. With the system 1 according to the invention, it is possible to unify the range of different identification services, in such a way that the user or consumer 2 is equipped with a single means of identification which is easy to handle, and which allows him to make use of a wide range of services and gain access to a wide range of venues 3.

In one possible embodiment, the user 2 can register himself on the forwarding device before using the data carrier 9. The identification of the user may be issued before or during the purchase of the access authorisation and the re-use.

In one possible embodiment, the user or consumer 2 is issued a user identification by the forwarding device upon first using the method. This has the advantage that the user 2 does not have to meet any further requirements for using the method, in such a way that anyone can participate in the access authorisation system. If a user identification has already been issued during a previous purchase, the same user identification can be re-used for as many events or venues 3 as desired.

In a preferred embodiment, the access report device 8 or card sales device 8 does not have direct access to the access read device 10. The ticket sales or access report device 8 only has access to the access read devices 10 indirectly via the forwarding device 6, in such a way that the forwarding device forms an additional control instance. In this embodiment, the access report device 8 or ticket sales device 8 is for example a web page, a call centre, a ticket office or a travel agency. The consumer and event data or user identifications N-ID and venue data are sent from the access report device 8 to the forwarding device 6. The identifications of the consumer 2 are determined within the forwarding device 6 and forwarded to the access read devices 10. Since only the forwarding device 6 has access to the access read devices 10, the user identifications of the consumer or user 2 are only passed on internally within the system. This in turn is highly advantageous for the security of the system 1, since the user identifications and venue data or venue times never leave the system 1 and thus cannot be intercepted. In one possible embodiment, the forwarding device 6 provides that no third party gains access to the access read devices 10. This can for example be provided in that the data are forwarded encrypted to the access read devices 10. Both symmetrical and asymmetrical cryptographic encryption methods are suitable for this purpose. In a further possible embodiment, it may be provided that the forwarding device 6 itself has to identify itself on the access read device 10 so as to be able to forward data to the access read device 10. The data is forwarded for example over a wired or wireless connection. The data may for example be forwarded via the Internet or a mobile radio telephone network.

The forwarding device 6 can be used for further services. For example, the forwarding device 6 can be used to forward bills, confirmations, booking confirmations or reservations electronically to users or customers 2. In one possible embodiment, a further customer database is provided for this purpose, and stores customer data such as e-mail addresses or mobile telephone numbers of users 2. These data may be managed by the forwarding device 6 in a central database. In one possible embodiment, the database preferably further comprises the necessary information for forwarding the necessary data to the access read devices 10. In one possible embodiment, these data comprise an identification of the access read device 10 itself, an identification or user identification of the customer, and the type and/or duration of the access authorisation. In one possible embodiment, a user 2 is given the possibility of obtaining an access authorisation to a venue 3 for a predetermined period, for example a plurality of hours. Once the access authorisation has expired, the user 2 may for example receive a corresponding message via a mobile terminal, and be asked to leave the venue 3 again because his access authorisation has expired. For example, a user 2 obtains an access authorisation to a closed-off venue 3, for example a zoo, for a predetermined period of for example four hours. Once this access authorisation time has expired, the user is asked by the forwarding device 6 to leave the closed-off venue 3 again, that is to say the zoo, within a particular time. If the user 2 does not leave the venue 3 within this period, he will be asked to pay again, for example at an exit barrier.

In one possible variant embodiment of the system 1 according to the invention, the access read devices 10 of the corresponding event are additionally automatically detected, from the event or venue which was booked by the user 2, by the forwarding device 6, for example by means of database entries, the user's 2 user identification ultimately being forwarded automatically to the detected access read device or devices 10.

In this variant embodiment, the security of the system 1 is further increased. Since the access read devices 10 which are associated with the venues or events are first detected by the forwarding device 6, anyone who gains access to the ticket sales device or the server of the access report device 8 cannot discover which access read device 10 is being used for the respective event or the respective venue 3. This in turn limits the possibility of unauthorised access to the venue. A further advantage of this variant embodiment is that in this context only the user identification of the consumer or user is forwarded to the respective access read devices 10 which are actually set up at the respective venue 3.

In a further possible embodiment of the system 1 according to the invention, an identification is additionally inputted into the access read device for identifying the consumer or user 2, the access read device 10 only granting the user 2 access to the venue 3 in the case of successful identification both by way of the read-off user identification and by way of the additionally inputted user identification. For example, in this variant embodiment, in addition to submitting the portable data carrier 9 for a user identification N-ID to be read off, the user may be required to input a password which he has stored into the access read device 10 via an input means, for example a keyboard. As a result, the security of the system 1 according to the invention can be further increased. In this variant embodiment, in addition to the identification, the user 2 has do take note of a password for example and input this password into the access read device 10 so as to identify himself successfully.

In a possible further variant embodiment of the system 1 according to the invention, the user identification N-ID of the user or consumer 2 is read off from a mobile read-off device or from a mobile terminal 9 via the access read device 10 so as to identify the user 2 and grant access to the event by means of the access read device 10. An advantage of this variant embodiment is that the user 2 does not have to take note of an identification number or user identification himself, in such a way that it is possible to use a relatively complex identification or device number, which for example comprises a large number of bits, for example a binary number of 32 bits length.

In one possible variant embodiment, the portable data carrier is formed by a transponder, it being possible for the transponder to comprise an RFID chip. In one possible embodiment, this RFID chip is located on a user card. Furthermore, it is possible for the RFID chip to be attached to a mobile terminal of the user 2 by means of a sticker. An advantage of this embodiment is the simple accommodation of the transponder. In one possible embodiment, the RFID chip is in the form of a passive transponder and therefore does not require a separate energy source so as to return a request signal to the access read device 10 for reading off the user identification. This in turn makes it possible to accommodate the portable data carrier 9 in very tight spaces. Therefore, an RFID chip of this type can also readily be located in a user card or an adhesive strip. The advantage of a user card or adhesive strip of this type, which may for example be fastened to a mobile terminal, is the mobility. User cards of this size will fit in any purse or wallet and can therefore easily be carried around by the user 2.

In a further possible embodiment, the portable data carrier 9 is a mobile telephone, the MAC address of which can serve as a user identification. Thus, in this embodiment, an identification which is readily carried around, for example the MAC address of the mobile telephone, is used as an identification or user identification, which is internal within the system, in the access system 1 according to the invention. In this variant embodiment, an RFID card or user card can be issued once for the user or consumer by the organiser.

In a further embodiment, the user identification is stored on a magnetic strip, it being possible for the magnetic strip to belong to a credit card. The advantage of this variant embodiment is that an identification which can readily always be carried around by the user, that is to say data which are stored on the magnetic strip of the credit or debit card, is used for identification internally within the system in the access authorisation system according to the invention.

The system 1 according to the invention makes it possible for the user to purchase entry tickets from a wide range of vendors, for sports, event, travel and free time activities, at a card sales device or an access report device 8. After the purchase, the access report device 8 automatically transmits the user identification for the various purchased access rights to the forwarding device 6 as an electronic dataset. The forwarding device 6 is connected to the various access read devices 10, which can in turn read off the portable data carriers 9. In the system 1 according to the invention, sending or even printing, as with previously known paper-based entry tickets, does not take place or is no longer required. For identification as an authorised entrant, on site, or as an authorised purchaser, in the card sales device or access report device 8, the user 2 only needs one identification, which may for example be stored to an RFID chip which is integrated onto a user card. This user card can be used as a personal access key by the user 2, and moreover makes it possible for the user or consumer 2 to use it as a credit card. In one possible embodiment, an RFID chip or an RFID transponder is used as a portable data carrier 9, each RFID transponder being associated with one person or one user 2 by way of the single identification, which is unique worldwide, on the access system 1 according to the invention. RFID transponders of this type may for example be attached to a housing of a mobile telephone or to a battery housing. In one possible embodiment, the access authorisation system 1 according to the invention is connected to an billing system for billing for the user orders.

Further variants of the access authorisation system 1 according to the invention are possible. In one possible variant, a user 2 only gains access to a closed-off venue 3 together with a further registered user. For example, a young user only gains access to a venue 3 when accompanied by an adult user. In this variant embodiment, there are thus various types of users 2 who are distinguished, in the example given, by the attribute “age”. In this way for example parents can ensure that younger siblings always participate in a particular event under the supervision of older siblings or an adult.

In a further variant embodiment, the venue 3 is a particular path between a particular entrance and a particular exit within a system, the access authorisation system 1 controlling, by means of a plurality of access read devices 10, a particular path which the user 2 can take within the region. In this variant embodiment, the access authorisation system 1 according to the invention may for example ensure that a user 2 always ends up in the right queue for a counter, for example in an administrative agency.

In a further variant embodiment, the portable data carrier 9 is not carried directly by a person 2 as the user, but is attached for example to a vehicle operated by a user 2. For example, the data carrier 9 is located on a passenger motor vehicle which is controlled by the user 2. In this variant embodiment, the user 2 controls a motor vehicle for example in a closed-off car park, and gains access to the car park after successful identification of the user identification which is stored in the data carrier 9 of the motor vehicle. Once access has been granted, the forwarding device 6 can subsequently additionally transmit a parking space number to a terminal of the user 2 as location information data, which is displayed to the user 2 on a display of the vehicle for example.

Further variants are possible. For example, the mobile data carrier 9 can be attached to a sports device of the user 2, for example his ski. In this variant embodiment, the user gains access to a skiing area through an access read device 10, for example.

In a further possible variant embodiment, the access read device 10 is integrated into a mobile vehicle and is thus itself mobile. In a possible variant embodiment, the access read device 10 is connected to a data network 4 via mobile IP and can in this way obtain user identifications N-ID of persons or users 2 having access authorisation.

In a further variant embodiment, the mobile data carrier 9 is implanted in the user 2. In a further possible variant embodiment, the user's 2 access to a closed-off region 3 is reported to a monitoring device, which is thus made aware of the location 3 where the respective user 2 is currently located.

From the preceding examples, it is clear that there are a large number of different variant embodiments in which the system 1 according to the invention for electronically providing an access authorisation can be used. Moreover, the access authorisation system 1 according to the invention can be used universally for a wide range of venues 3. In this context, the system 1 according to the invention is particularly secure against manipulation and can be used by an organiser without any major additional administrative expenditure. The system 1 according to the invention preferably sets up user identifications N-IDs of a user 2 which are readily available on a portable data carrier 9, for example an electronic identity card. The system 1 according to the invention can thus be implemented in a simple manner without major expenditure, in particular without issuing additional individual means of identification.

1. System for electronically providing an access authorisation for a user, to a location selected by the user, comprising at least one access report device, which reports a user identification (N-ID) of the user, which is in each case stored on at least one portable data carrier of an user having access authorisation, via a data network to a forwarding device, which electronically forwards the reported user identification (N-ID′) via the data network to at least one access read device, which is provided at the respective selected location and which grants the user access to the selected location if the user identification (N-ID) which is stored on the user's portable data carrier and is read off from the data carrier by the access read device corresponds to the user identification (N-ID′) which is electronically forwarded to the access read device.

2. System according to claim 1, wherein the access read device which is provided at the respective selected location locally compares the user identification (N-ID) which is read out from the user's portable data carrier with user information (N-ID′) which is electronically forwarded to the access read device by the forwarding device, and only grants the user access to the location if the user identification (N-ID) which is read off from the user's portable data carrier matches a user identification (N-ID′) which is electronically forwarded to the access read device by the forwarding device.

3. System according to claim 2, wherein, after being installed and set in operation at the respective location, an access read device reports to the forwarding device and electronically receives the user identifications (N-ID′) of the users who have selected the respective location.

4. System according to claim 1, wherein the access read device which is provided at the respective location sends the user identification (N-ID) which is read of from the user's portable data carrier to the forwarding device, which centrally compares the user identification (N-ID) received from the access read device with all of the stored user identifications (N-ID′) of registered users who have selected the respective location, and sends an access authorisation grant message to the access read device if the received user identification (N-ID) matches one of the stored user identifications (N-ID′), wherein the access read device grants the user access to the location after receiving the access authorisation grant message.

5. System according to claim 1, wherein the portable data carrier is an electronic identity card of the user, comprising a readable identity card number as the user identification.

6. System according to claim 1, wherein the portable data carrier is a mobile terminal of the user, comprising a readable device number of the terminal as the user identification, wherein the mobile terminal is a mobile telephone, a laptop, a smartphone or a PDA.

7. System according to claim 1, wherein the portable data carrier is a user card or a user chip of a user who is registered on the forwarding device, comprising a readable member number as the user identification.

8. System according to claim 5, wherein the user registers himself as a member on the forwarding device with one or more user identifications (N-ID) of the user (2).

9. System according to claim 1, wherein the access authorisation to the respective location can be transferred from one registered user to another registered user, in that the user having access authorisation reports the transfer to the forwarding device while specifying the other user, wherein the forwarding device replaces the user identification (N-ID) of the reporting user with the user identification of the other user for the respective location.

10. System according to claim 6, wherein the access read device which is provided at the location additionally compares the spatial coordinates of the mobile terminal which is used as the portable data carrier with its own spatial coordinates, and only grants access to the location if the spatial coordinates virtually match.

11. System according to claim 4, wherein the user carries around a plurality of portable data carriers, which each have their own user identification (N-ID) of the user, wherein the access read device only grants access to the location (3) if all of the user's user identifications (N-IDs) which are read off from the various data carriers correspond to the associated user identifications (N-IDs') which are electronically forwarded to the access read device.

12. System according to claim 1, wherein the location is a defined venue, for example a concert venue, a theatre venue, a cinema venue, a sports venue, an exhibition venue or a conference venue, or is a defined region within a building or is a passenger transport means.

13. System according to claim 1, wherein, after access has been granted, the forwarding device receives an access report for the respective user from the access read device, and forwards further specific location information data to the user, in particular a seat number, a standing region block number, an exhibition stand number, a parking space number or a ski lift number.

14. Access read device for an access authorisation system, comprising:
an interface for reading off a user identification (N-ID) from a user's portable data carrier, an interface for receiving an electronically forwarded user identification (N-ID′);
and comprising an evaluation unit, which compares the read-off user identification (N-ID) with the received user identification (N-ID′) and grants the user access to the location if the user identification (N-ID) which is read off from the data carrier matches the electronically forwarded user identification (N-ID′).

15. Forwarding device for an access authorisation system, comprising:
an interface for receiving a user's user identification (N-ID) and a location which has been selected by the user; and comprising an evaluation unit, which compares the received user identification (N-ID) with user identifications (N-ID′) which are stored in a database, and, if they match, electronically forwards the user identification (N-ID) to at least one access read device which is provided at the respective location.

16. Method for electronically providing an access authorisation for a user, wherein a user identification (N-ID) which is stored on a portable data carrier of the user and a location which has been selected by the user are reported to a forwarding device, which forwards the reported user identification (N-ID) to at least one access read device which is provided at the respective location and which grants the user access to the location if the user identification (N-ID) which is stored on the user's data carrier and which is read off from the data carrier by the access read device corresponds to the user identification (N-ID′) which is electronically forwarded to the access read device.

17. System according to claim 6, wherein the user registers himself as a member on the forwarding device with one or more user identifications (N-ID) of the user.

18. System according to claim 7, wherein the user registers himself as a member on the forwarding device with one or more user identifications (N-ID) of the user.
